(19) United States
(12) Patent Application Publication
(10) Pub. No.: US 2007/0256750 A1
(43) Pub. Date: Nov. 8, 2007

(54) CENTRALISER

(75) Inventor: Mark James CROOK, Norwich (GB)

Correspondence Address: BURR & BROWN, PO BOX 7068, SYRACUSE, NY, 13261-7068, US

(73) Assignee: U.W.G. Limited, Norwich (GB)

(21) Appl. No.: 11/694,010

(22) Filed: Mar. 30, 2007

(30) Foreign Application Priority Data
Apr. 4, 2006 (GB) 0606751.6

(51) Int. Cl. F16L 3/01

(52) U.S. Cl. 138/113; 138/112

(57) ABSTRACT

A centraliser for centring one pipe within another comprises a plurality of skids which extend outwards from the outer surface of an inner pipe into contact with the inner surface of an outer pipe The skids are independent of one another and are secured to the outer surface of a pipe with the skids extending radially from the pipe surface. The skids have apertures to receive a securing band or bands which can be passed around the pipe, received in the apertures of the skids and tensioned to secure the skids to the pipe surface.

### BACKGROUND

a. Field of the Invention

The present invention relates to a centraliser, and in particular to a centraliser for use in the oil and gas industry.

b. Related Art

It is common in the extraction and production of oil or gas to use a drill pipe that comprises two circular pipes, one received within the other. Conventionally, a number of centralisers will be fitted to the inner pipe to prevent the inner pipe from making contact with the outer pipe, as this may lead to a shortening of the operational life of the pipes. Furthermore, it is also common practice for the outer pipe to be centralised when it passes through guides on platforms.

Typically a centraliser will comprise a number of skids that extend out from the inner pipe to make contact with the outer pipe. These members may be fixed or they may be radially adjustable in order to allow the centraliser to be fitted to the gap between the inner and outer pipes. Examples of adjustable centralisers are given in our earlier applications GB 2 381 280 and GB 0419247.2.

### SUMMARY OF THE INVENTION

According to the present invention there is provided a centraliser for centring one pipe within another, the centraliser comprising a plurality of skids and means for securing the skids to the outer surface of a pipe with the skids extending radially from the pipe surface, each of the skids comprising at least one aperture to receive a securing means, and the securing means comprising at least one band which can be passed around the pipe, received in the apertures of the skids and tensioned to secure the skids to the pipe surface

The skids are preferably formed from a plastics material such that they can be cut to an appropriate size to fit between inner and outer pipes. The skids may also be deformable under compression such that the action of securing a skid to the inner pipe causes the region of the skid in contact with the inner pipe to adopt the curvature of the inner pipe.

The aperture in each of the skids may comprise a region where the radially extending surface of the skid is cut back to form a recessed area for receiving the securing means, or the aperture could comprises a hole through the radially extending surface of the skid through which the securing means can be passed.

In a particularly suitable embodiment, there can be four skids and two securing bands. The bands can be metal or plastics straps.

The aperture in each of the skids may comprise a slot formed within the skid or a hole having a rectangular, oval or square shape.

Previous centralisers have been designed for use in environments, such as the North Sea, where the mechanical load on drill pipes and centralisers can be significant and thus centralisers must be engineered appropriately to provide the required operational lifetime. It has been realised that in more benign environments, such as the Persian Gulf for example, the mechanical loads that will be exerted on the centralisers will be significantly less. This means that the centralisers can be redesigned to be less robust and that the installation process can be reengineered to be less complex and less time consuming. The results of this is that the centraliser is less expensive to manufacture and is less expensive for an operator to install onto their production facilities.

By forming the centralisers from a plastics material, it is possible to produce a single product that can then be cut, or processed, to the appropriate size prior to installation. As the centralisers are to be used with pipes having a wide range of diameters, for example a pipe diameter of 550-900 mm (22-36 inches), and with varying spaces between outer pipes and guides then this can reduce the complexity and cost of having to stock different size centralisers for use with pipes of different diameters. Furthermore, the use of a single product for these different centraliser uses leads to economy of production.

### BRIEF DESCRIPTION OF THE DRAWINGS

The invention will now be described, by way of example only, with reference to the following Figure in which:

FIG. 1 shows a schematic depiction of a centraliser according to the present invention.

### DETAILED DESCRIPTION

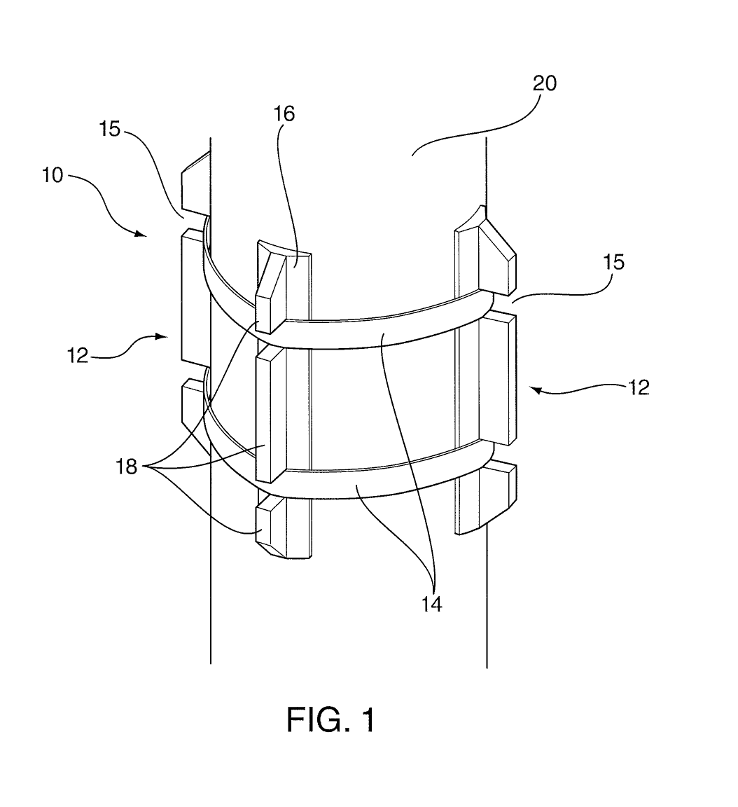

FIG. 1 shows a schematic depiction of a centraliser 10 according to the present invention which comprises a plurality of skids 12 and one or more securing means 14. Each of the skids 12 comprise a base region 16 and one or more contact regions 18, which extend radially from the base region 18. In use, the one or more securing means 14 are secured circumferentially to the inner pipe 20 and pass through one or more apertures 15 in the skids. The plurality of skids are formed such that the one or more contact regions 18 are in contact with, or very near to being in contact with the inner surface of an outer pipe (not shown) that is arranged around the inner pipe. This arrangement of the centraliser will reduce relative movement between the inner pipe and the outer pipe.

FIG. 1 shows a centraliser having four skids with the fourth being out of sight, behind the pipe. It will be understood that the present invention could be implemented using two or more skids but the use of four skids is believed to provide the optimum balance between the cost and the performance of the centraliser

Preferably the skids are formed from a plastics material, for example by extrusion, moulding or by other suitable technique. The choice of material is not critical to the teaching of the present invention, but it is believed that nylon or polyurethane would be suitable plastics materials for forming the skids. The skids may also be formed from a metal, for example aluminium.

When the skid is formed the contact regions have a radial extent that is greater than the maximum required separation between an inner and an outer pipe. The skid can then be cut or machined to the required size in order to provide the required support between the inner and outer pipes. In use the securing means will compress the base 16 of each skid against the inner pipe such that the base adapts itself to the curvature of the inner pipe.

FIG. 1 shows that the skids have a plurality of apertures 15 that accept the securing means 14. It will be understood that the skids may comprise any number of apertures as are required to secure the skid to the inner pipe. Furthermore, the width of the apertures may be variable in order to accommodate securing means having different widths. It may be necessary to reinforce the skid in the region of the apertures. This may be achieved by inserting a reinforcement member over the aperture or alternatively by forming the skid such that the material in the region of the aperture is harder than the rest of the skid. This may be achieved by using a different grade of material in this region of the skid or by adding a reinforcing material (for example glass fibres or similar) to the material used to form the region.

In an alternative embodiment, the skid may comprise a single contact region 18, in which is formed one or more rectangular or square holes, through which the securing means can be passed, prior to the securing means being used to secure the skids to the inner pipe. In this case, a reinforcing means may be applied to the interior of the aperture, such as a metallic insert, to prevent the compressive force applied by the securing means from damaging the skid.

The securing means are preferably a simple metallic strip that can be placed around the inner pipe and around (or through) the skids and then tensioned appropriately. The securing means can then be fastened together and any excess removed. For example. It is understood that the Band-it™ straps and Ultra-Lok™ buckles that are supplied by Band-It Limited, would be suitable for use as the securing means of the present invention. Such products can be simply installed using a pneumatic or electrical tool.

The centraliser described here is extremely simple but effective and adaptable to a wide variety of pipe diameters. The same skids can be secured to pipes of widely different diameters, and this avoids the need to specify the pipe diameter when sourcing the centraliser components and avoids having to manufacture and stock a large range of different centralisers for different sizes of pipes.

1. A centraliser for centring one pipe within another, the centraliser comprising a plurality of skids and means for securing the skids to the outer surface of a pipe with the skids extending radially from the pipe surface, each of the skids comprising at least one aperture to receive a securing means, and the securing means comprising at least one band which can be passed around the pipe, received in the apertures of the skids and tensioned to secure the skids to the pipe surface.

2. A centraliser as claimed in claim 1, wherein the skids are formed from a plastics material which can be cut to reduce the radial extent of the skids to fit between the outer surface of the pipe and the inner surface of another, larger diameter pipe.

3. A centraliser as claimed in claim 1, wherein the skids are deformable under compression such that the action of securing a skid to a pipe surface causes the region of the skid in contact with the pipe to adopt the curvature of the pipe.

4. A centraliser as claimed in claim 1, wherein the aperture in each of the skids comprises a region where the radially extending surface of the skid is cut back to form a recessed area for receiving the securing means.

5. A centraliser as claimed in claim 1, wherein the aperture in each of the skids comprises a hole through the radially extending surface of the skid through which the securing means can be passed.

6. A centraliser as claimed in claim 1, wherein the apertures are reinforced where they will be in contact with the securing bands.

7. A centraliser as claimed in claim 1, wherein there are four skids and two securing bands.

8. A centraliser as claimed in claim 1, wherein the bands are metal straps which can be tensioned around the pipe and the skids, and then locked to themselves.

9. A centraliser as claimed in claim 1, wherein the bands are plastics straps which can be tensioned around the pipe and the skids, and then locked to themselves.
